(19) United States
(12) Patent Application Publication
(10) Pub. No.: US 2026/0203652 A1
(43) Pub. Date: Jul. 16, 2026

(54) Knowledge Distillation using Hybrid Loss Function for Different Sample Types

(71) Applicant: Microsoft Technology Licensing, LLC, Redmond, WA (US)

(72) Inventors: Jongwoo KO, Seoul (KR); Tianyi CHEN, Kenmore, WA (US); Tianyu DING, Redmond, WA (US); Luming LIANG, Redmond, WA (US); Ilya Dmitriyevich ZHARKOV, Niwot, CO (US)

(73) Assignee: Microsoft Technology Licensing, LLC, Redmond, WA (US)

(21) Appl. No.: 19/025,011

(22) Filed: Jan. 16, 2025

(51) Int. Cl. G06N 20/00

(52) U.S. Cl. CPC G06N 20/00

(57) ABSTRACT

A technique is described for training a student model based on a larger teacher model. The training includes generating a loss measure having a contrastive combination of two parts. The first part is based on a forward measure of divergence between teacher-generated and student-generated probability distributions, which, in turn, are based on teacher-generated samples. The second part is based on a reverse measure of divergence between student-generated and teacher-generated probability distributions, which, in turn, are based on student-generated samples. The technique then updates parameters of the student model based on the loss. In some implementations, the first part of the loss is generated using forward Kullback-Leibler (KL) divergence, and the second part of the loss is generated using reverse KL divergence. The technique also involves dynamically updating hyper-parameters during training.

### BACKGROUND

Machine-trained models have proven capable of generating accurate responses in a variety of applications. However, many models achieve their success by incorporating a relatively large number of machine-trained parameters. Computing devices require a significant amount of resources to store and run these kinds of models. This drawback limits the types of applications and platforms that are capable of successfully running the models.

Knowledge distillation is one technique that has been used to reduce the size of large models. Knowledge distillation involves training a student model to approximate the behavior, and associated probability distribution, of a larger teacher model. There nevertheless remains room for improving the accuracy and efficiency at which knowledge distillation techniques transfer knowledge from teacher models to student models. For instance, a student model may learn an overly smooth distribution that fails to capture the complexity of the teacher model's distribution and its various modes. This phenomenon is referred to as mode averaging or mode collapse.

### SUMMARY

A technique is described for training a student model based on a larger teacher model using a loss function having a contrastive combination of two parts. The first part is based on a forward measure of divergence between teacher-generated and student-generated probability distributions, which, in turn, are based on teacher-generated samples. The second part is based on a reverse measure of divergence between student-generated and teacher-generated probability distributions, which, in turn, are based on student-generated samples. The technique then updates parameters of the student model based on the loss.

According to some implementations, the student model and the teacher model are respective language models.

According to some implementations, the first part of the loss is generated using forward Kullback-Leibler (KL) divergence, and the second part of the loss is generated using reverse KL divergence. More specifically, in some implementations, the loss function uses skew versions of forward and reverse KL divergence. A skew version differs from its non-skew counterpart by interpolating between a student-generated distribution and a teacher-generated distribution.

According some implementations, the technique involves dynamically updating hyper-parameters during training.

The technique is technically advantageous because it accelerates convergence to a target training goal. Further, the technique allows the student model to accurately approximate the behavior of the larger teacher model, with reduced risk of mode averaging.

The above-summarized technology can be implemented by various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a training system for training a student model based on a larger teacher model.

FIG. 2 shows an example of the characteristics of forward and reverse KL divergence.

FIG. 3 shows an example of characteristics of a loss function used by the training system of FIG. 1.

FIG. 4 shows a process that describes one manner of operation of the training system of FIG. 1.

FIG. 5 shows a process that describes one manner of dynamically updating an interpolation parameter α.

FIG. 6 is a chart that demonstrates the performance of a student model that is trained using the training system of FIG. 1.

FIG. 7 is a chart that isolates the performance-related effects of different features of the training system of FIG. 1.

FIG. 8 shows an illustrative language model for implementing various functions of the training system of FIG. 1.

FIG. 9 shows a process that describes the operation of the training system of FIG. 1.

FIG. 10 is another process that represents a more detailed implementation of the process of FIG. 9.

FIG. 11 shows computing equipment that, in some implementations, is used to implement the training system of FIG. 1.

FIG. 12 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Overview of the Training System

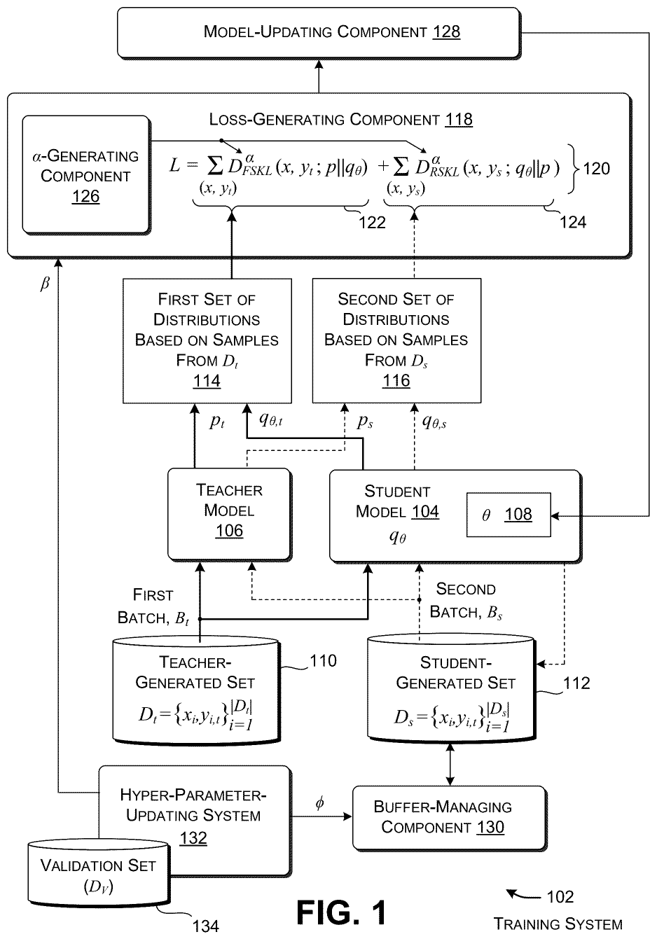

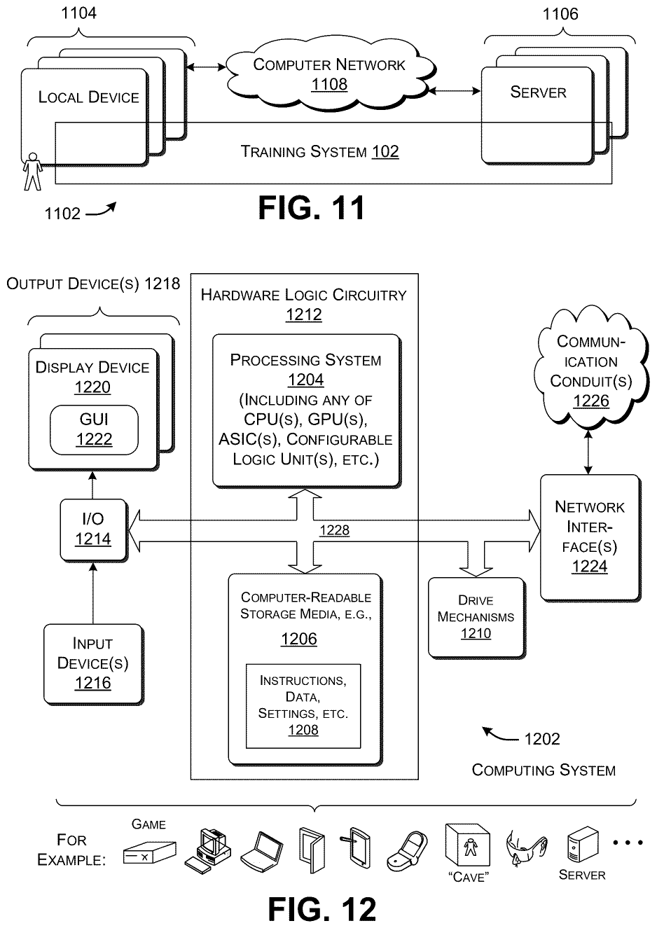

FIG. 1 shows a training system 102 for training a student machine-trained model (“student model”) 104 to approximate the behavior and associated probability distribution of a larger teacher machine-trained model (“teacher model”) 106. A machine-trained model refers to any type of computer-implemented logic for performing a function based on machine-trained parameters (e.g., filter weights and bias parameters). In some contexts, the more general terms “component,” “module,” “engine,” and “tool” refer to parts of computer-based technology that perform respective functions. FIGS. 11 and 12, described below, provide examples of illustrative computing equipment for performing these functions

Examples will be presented herein in which the student model 104 and the teacher model 106 are respective language models that operate in an autoregressive manner. To cite one example, the student model 104 is a Qwen2 language model having 1.5B parameters and the teacher model 106 is a Qwen2 language model having 7B parameters. General background on the Qwen2 language model is available at Yang, et al., “Qwen2 Technical Report,” arXiv, arXiv: 2407.10671v4 [cs.CL], Sep. 10, 2024, 24 pages. More generally, the student model 104 and the teacher model 106 are capable of performing any function(s) using any architecture(s). For example, the student model 104 and the teacher model 106 may represent transformer-based autoregressive language models, BERT-type single-pass language models, convolutional neural networks, recurrent neural networks, diffusion models, selective state space language models, etc. Further, the student model 104 and the teacher model 106 may share the same architecture, but this need not be the case in all implementations. Further, the teacher model 106 and the teacher model 106 are capable of operating on input information having any type or combination of types (including text information, image information, video information, audio information, etc.). For example, the principles set forth herein are applicable to the task of training a student visual language model (VLM) to approximate the distribution of a larger visual language model.

The training system 102 updates a set of parameters θ 108 of the student model 104 in a series of iterations. The teacher model 106 itself is considered fully trained and capable of providing accurate responses to input queries. As such, the parameters of the teacher model 106 remain fixed throughout training. However, the principles set forth below can be extended to implementations in which the parameters of the teacher model 106 are also updated.

The student model 104 and the teacher model 106 operate on input samples from two sources: a teacher-generated set Dₜ of teacher-generated samples in a first data store 110 and a student-generated set Dₛ of student-generated samples in a second data store 112. In some implementations, the second data store 112 functions as a replay buffer. Each sample includes a pair of data items (x, y). For example, in the context of a text-based language model, the data item x is a query having one or more text tokens, and the data item y is a response to the data item x, also including one or more text tokens. (A “token” refers to a unit of information processed by a machine-trained model, such as a word or a part of a word.) More specifically, the symbol yₜ indicates that a response originates from the teacher-generated set, while the symbol yₛ indicates that a response originates from the student-generated set. The number of samples |Dₜ| in the teacher-generated set may be different (e.g., greater) than the number of samples |Dₛ| in the student-generated set.

The teacher-generated samples are considered correct by definition. For example, in some examples, the teacher model 106 has previously generated the teacher-generated samples, or some other trusted process or human expert has provided the teacher-generated samples. On the other hand, the student-generated samples are produced by the student model 104. More specifically, in some implementations, the training system 102 uses the student model 104 to produce all of the student-generated samples before training begins. In other implementations, the training system 102 invokes the student model 104 at various junctures during the training to produce subsets of student-generated samples. In either case, because the student model 104 produces the student-generated samples before it has fully assimilated the knowledge of the teacher model 106, and because the student model 104 is less powerful than the teacher model 106, there is less certainty about the correctness of the student-generated samples compared to the teacher-generated samples.

The student model 104 and the teacher model 106 are capable of mapping an individual sample into a probability. For example, a language model maps a data item x into logits, and then uses a Softmax operation (which is a normalized exponential function) to map the logits into probabilities for respective candidate tokens in a vocabulary V of tokens. Each probability associated with a particular candidate token expresses a level of confidence that the candidate token is a correct interpretation of x. The probability associated with a complete response y is a combination of the individual probabilities associated with the individual tokens in the response. The language model identifies the probability associated with a particular pair (x, y) by identifying the probability computed by the Softmax component for the particular y, given x.

A language model produces a probability distribution by mapping a plurality of samples to their respective probabilities in the above-described manner. For example, the teacher model 106 operates on the first batch of samples Bₜ from the teacher-generated set (in the data store 110) to produce a first teacher-generated probability distribution pₜ (where the t indicates that the samples originate from the teacher-generated set), and the teacher model 106 operates on a second batch of samples Bₛ from the student-generated set (in the second data store 112) to produce a second teacher-generated probability distribution pₛ (where the s indicates that the samples originate from the student-generated set). Similarly, the student model 104 operates on the first batch of samples Bₜ from the teacher-generated set to produce a first student-generated probability distribution q_{θ,t} (where the t indicates that the samples originate from the teacher-generated set), and the student model 104 operates on the second batch of samples Bₛ from the student-generated set to produce a second student-generated probability distribution q_{θ,s} (where the s indicates that the samples originate from the student-generated set).

The probability distributions (pₜ,q_{θ,t}) that have been generated based on samples that originate from the teacher-generated set form a first set of distributions 114. The probability distributions (pₛ,q_{θ,s}) that have been generated based on samples that originate from the student-generated set form a second set of distributions 116.

A loss-generating component 118 computes a loss measure L based the first set of distributions 114 and the second set of distributions 116. More specifically, the loss-generating component 118 applies a loss function 120 that includes a first part 122 and a second part 124. In general, the first part 122 and the second part 124 differ because: (a) they use different loss functions to measure the divergence between two probability distributions; and (b) they operate on probability distributions that are computed based on samples having different respective types (and different levels of confidence associated therewith). In the example of FIG. 1, the first part 122 processes probability distributions that are generated based on samples that originate from the teacher-generated set, while the second part 124 processes probability distributions that are generated based on samples that originate from the student set.

More specifically, in some implementations, the loss function 120 is generally given by:

$$L = {DivergeFunc}_{1} ( {p}_{t} , {q}_{θ , t} ) + DivergeFun {c}_{2} ( {p}_{s} , {q}_{θ , s} ) . \qquad ( 1 )$$

That is, the first part 122 measures the divergence of the teacher-generated probability distribution pₜ with respect to the student-generated probability distribution q_{θ,t} using a first divergence function (DivergeFunc₁). The second part 124 measures the divergence of the student-generated probability distribution q_{θ,s} with respect to the teacher-generated probability distribution tₛ using a second divergence function (DivergeFunc₂). The second divergence function is different than the first divergence function.

The divergence functions can use any techniques to express the extent to which two probability distributions diverge from each other. Examples are presented herein in which each divergence function is a variation of the Kullback-Leibler (KL) divergence. More specifically, the first part 122 is formulated as a forward KL divergence based on distributions computed based on samples which originate from the teacher-generated samples. The second part 124 is formulated as a reverse KL divergence based on distributions computed based on samples which originate the student-generated set.

A forward KL divergence between two probability distributions (p, q) of data items x in a set X of data items is given by:

$${D}_{F K L} ( p ‖ q ) = {\sum }_{x ∈ X} p ( x ) log ( \frac{p ( x )}{q ( x )} ) . \qquad ( 2 )$$

That is, Equation (2) computes, for each data item x, the log of the ratio of a probability p(x) to a probability q(x), and multiplies this result by the probability p(x). A reverse KL divergence reverses the role of p and q in Equation (2). That is, the reverse KL divergence is generally given by:

$${D}_{R K L} ( q ‖ p ) = {\sum }_{x ∈ X} q ( x ) log ( \frac{q ( x )}{p ( x )} ) . \qquad ( 3 )$$

In the context of language models, each data item y represents a response to an input data item x. Further, each data item y may be composed of G tokens. The language model generates each individual token y_{g} of the G tokens as a function of the input data item x and the generated tokens y_{<g} (if any) which precede the token y_{g}. A sequence-level formulation of the forward KL divergence involves performing the operations of Equation (3) with respect to each of the tokens in y, for each data item x, and summing the results:

$${D}_{F K L} ( x , y ; p ‖ {q}_{θ} ) = {\sum }_{x ∈ X} {\sum }_{g = 1}^{G} p ( {y}_{g} \vert {y}_{< g} , x ) log \frac{p ( {y}_{g} \vert {y}_{< g} , x )}{{q}_{θ} ( {y}_{g} \vert {y}_{< g} , x )} . \qquad ( 4 )$$

The sequence-level formulation of the reverse KL divergence is similarly computed, with the roles of p and q shown in Equation (4) being reversed. Other implementations use other expressions of the divergence between two distributions. Examples of such other formulations include: the squared Euclidean distance, the squared Hellinger distance, the Jensen-Shannon divergence (JS), the α-divergence, the chi-squared divergence, etc.

FIG. 1 specifically shows an example of the loss function 120 that uses skew formations of the forward and reverse KL divergences, as expressed by:

$$L = {\sum }_{( x , {y}_{t} )} {D}_{F S K L}^{{α}_{1}} ( x , {y}_{t} ; p ‖ {q}_{θ} ) + {\sum }_{( x , {y}_{s} )} {D}_{R S K L}^{{α}_{2}} ( x , {y}_{s} ; {q}_{θ} ‖ p ) . \qquad ( 5 )$$

That is, the first part 122 is implemented by a skew version of forward KL divergence (e.g., D_{FSKL}), while the second part 124 is implemented as a skew version of reverse KL divergence (e.g., D_{RSKL}). The skew version of forward KL divergence is referred to below as skew-forward KL divergence, and the skew version of reverse KL divergence is referred to below as skew-reverse KL divergence. Skew-forward KL divergence differs from its non-skew counterpart by replacing the student distribution q_{θ} with an interpolation of p and q_{θ}, governed by an interpolation parameter α₁, as given by:

$${D}_{F S K L}^{α} ( x , {y}_{t} ; p ‖ {q}_{θ} ) = {D}_{K L} ( x , {y}_{t} ; p ‖ ( {α}_{1} p + ( 1 - {α}_{1} ) {q}_{θ} ) ) . \qquad ( 6 )$$

Similarly, skew-reverse KL divergence differs from its non-skew counterpart by replacing the teacher distribution p with an interpolation of p and q_{θ}, governed by an interpolation parameter α₂, as given by:

$${D}_{R S K L}^{α} ( x , {y}_{s} ; {q}_{θ} ‖ p ) = {D}_{K L} ( x , {y}_{s} ; {q}_{θ} ‖ ( ( 1 - {α}_{2} ) p + {α}_{2} {q}_{θ} ) ) . \qquad ( 7 )$$

The skew versions of the forward and reverse KL divergences are useful to help stabilize the optimization process performed by the training system 102. They achieve this by producing a more stable gradient. More specifically, the teacher-generated set Dₜ in the first data store 110 may be larger than the student-generated set Dₛ in the second data store 112. This difference means that there are points where p(.) is greater than zero, while q(.) is close to zero. In such cases, there is a risk that the ratio p(.)/q(.) will approach a very large number (e.g., infinity), causing its associated gradient norm to explode. This, in turn leads to unstable optimization. The skew versions of the KL divergences effectively bound the gradient norm by an upper limit of (1−α)/α, which reduces the risk of exploding gradients.

In some implementations, the loss-generating component 118 includes an α-generating component 126 that dynamically generates the interpolation parameter α for each pairing of probabilities (pᵢ, qᵢ) associated with an individual sample i. Generally, the value of a for sample i is a function of the difference between pᵢ and qᵢ, meaning that, as the difference becomes larger, so does α. The following explanation will assume that the two parts (122, 124) use different respective interpolation parameters (α₁, α₂). Use of the symbol a without a subscript refers to either α₁ or α₂. In other implementations, however, the first part 122 and the second part 124 use the same interpolation parameter. Section B provides additional information regarding the operation of the α-generating component 126.

Generally, a relatively large α improves optimization stability and accelerates convergence, but it may impede the ability of the student model 104 to sufficiently learn informative knowledge. In contrast, a relatively small α allows the student model 104 to more effectively learn informative knowledge, but it reduces optimization stability and slows convergence. The α-generating component 126 attempts to achieve the greatest net benefit to a training run by choosing the value of a that is best suited for each individual pairing of probabilities. For a small difference between pᵢ and qᵢ (meaning that the probabilities are substantially similar), the α-generating component 126 will select a relatively small α. This is because there is reduced risk to stable optimization in this case, and it is possible to increase the difficulty to promote the learning of informative knowledge. For a large difference between pᵢ and qᵢ (meaning that the probabilities are substantially different), the α-generating component 126 will select a relatively large α. This is because the risk to stable optimization is heightened in this case, and it is prudent to promote stability at the expense of learning informative knowledge.

A model-updating component 128 updates the parameters θ 108 of the student model 104 based on loss information computed by the loss function 120. The model-updating component 128 performs this task using any machine-trained process, such as stochastic gradient descent in combination with back propagation. Overall, the training system 102 repeats the above-described process for multiple batches of samples until a desired degree of convergence is achieved or some other target state is obtained.

In some implementations, a buffer-managing component 130 instructs the student model 104 to produce subsets of new student-generated samples throughout the training process. The buffer-managing component 130 then adds these new student-generated samples to the second data store 112 on a first-in-first-out (FIFO) basis, e.g., by evicting the N oldest samples to make room for N new samples. In other implementations, the buffer-managing component 130 instructs the student model 104 to produce all of the student-generated samples at the start of training, and no updating of this set occurs during training.

A hyper-parameter-updating system 132 produces various hyper-parameters that serve a role in controlling the behavior of the training system 102. For example, the hyper-parameter-updating system 132 generates a part-weighting parameter β that governs the importance of the first part 122 relative to the second part 124 of the loss function. For example, β modifies the loss function 120 as follows:

$$L = ( 1 - β ) \cdot {DivergeFunc}_{1} ( {p}_{t} , {q}_{t} ) + β \cdot {DivergeFunc}_{2} ( {p}_{s} , {q}_{s} ) . \qquad ( 8 )$$

In some implementations, the value of β remains static throughout the training process. In other implementations, the hyper-parameter-updating system 132 increases the value of β as training progresses. Section B provides further information regarding the updating of the parameter β.

In some implementations, the hyper-parameter-updating system 132 also generates a parameter φ that is used by a buffer-managing component 130 to govern the frequency at which new samples are added to the second data store 112 during training. The hyper-parameter-updating system 132 generates the value of φ based on the results of a validation process. The validation process involves measuring the accuracy of the student model 104 at a current point in time with respect to a set of validation samples in a data store 134, e.g., using cross entropy or any other loss measure. The hyper-parameter-updating system 132 increases the value of φ if the validation process indicates that the student model 104 has moved closer a target goal of convergence by a prescribed amount.

In some implementations, the buffer-managing component 130 uses the parameter φ in the following manner. For each iteration, the buffer-managing component 130 generates a random value u, and then determines whether this value is less than a value

$${λ}_{R} = ϕ ( 1 - \frac{m}{M} ) .$$

If so, the buffer-managing component 130 uses the student model 104 to generate a new subset of student-generated samples and then stores the student-generated samples in the second data store 112 on a FIFO basis. If this condition is not met, the buffer-managing component 130 will omit the step of generating new student-generated samples for the current iteration.

More generally, based on the above-described considerations, the buffer-managing component 130 will decrease the frequency at which it adds new student-generated samples to second data store 112 as training progresses. This also means that the training system 102 will increase the extent to which it re-uses old student-generated samples in the second data store 112 as training progresses. Again note, however, that other implementations generate all of the samples in the second data store 112 in advance, and therefore omit the above-described iterative buffer-managing process.

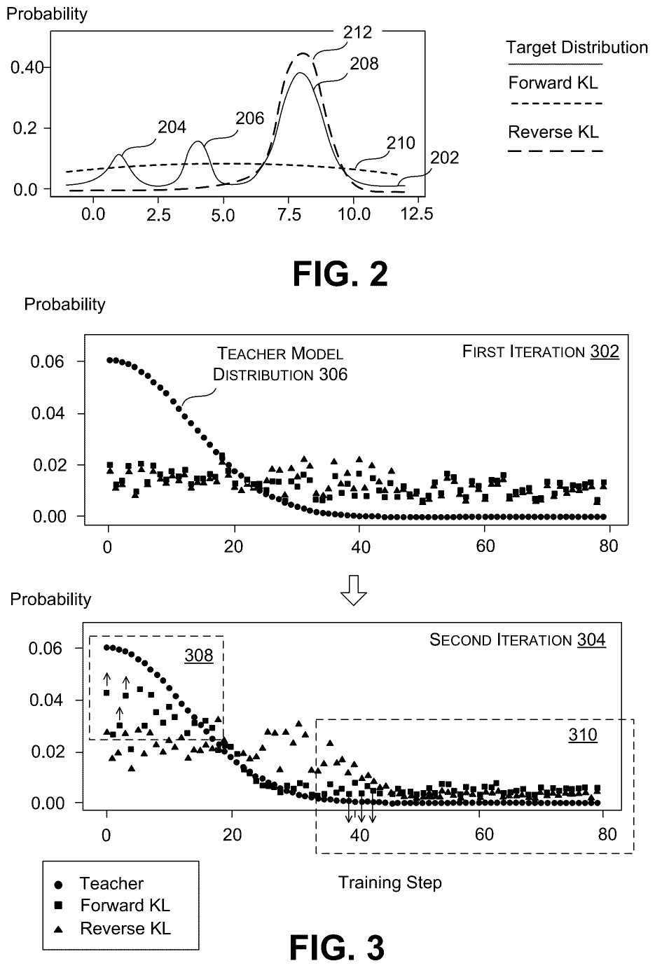

FIGS. 2 and 3 serve as vehicles for explaining some of the technical advantages of the loss function 120 composed of two parts (122, 124). Beginning with FIG. 2, this figure shows the effects of forward KL and reverse KL on a learnable student distribution q, given a target distribution p 202 having at least three modes (204, 206, 208). Forward KL divergence has the effect of averaging and flattening out the modes, to produce a student distribution q 210. Reverse KL divergence has the effect of following one of the modes, here, the third mode 208, to produce a student distribution q 212. These characteristics arise, in part, based the mathematical characteristics of forward KL divergence and reverse KL divergence, particularly with respect to the behavior of these divergences when one of the distributions has values close to zero.

FIG. 3 shows the separate effects of forward KL divergence and reverse KL divergence on a student-generated distribution q, in which a first panel 302 shows a state before training is applied and a second panel 304 shows a state after training has been applied. Assume that the teacher-generated samples have a probability distribution p 306, e.g., as reflected by the probability distribution produced by the teacher model 106 for the teacher-generated samples. The square-shaped points represent a student-generated probability distribution q trained under forward KL divergence, and the triangle-shaped points represent a student-generated probability distribution q trained under reverse KL divergence.

The loss-minimizing characteristics of the training system 102 generally produce the following effects. Forward KL divergence attempts to prevent p(⋅|x) over q(⋅|x) from approaching positive infinity. To achieve this, q(⋅|x) is increased in those regions in which p(⋅|x) is high (p>>0), such as a head region 308. On the other hand, reverse KL divergence attempts to reduce q(⋅|x) over p(⋅|x). To achieve this, q(⋅|x) is decreased in those regions in which p(⋅|x) is close to zero, such as a tail region 310. Based on the fact that the forward KL divergence and the reverse KL divergence attempt to move the student probability distribution in opposite directions, the loss function 120 as a whole (which combines forward KL divergence and reverse KL divergence) may be considered as a kind of contrastive loss function.

The allocation of different kinds of sample types (teacher-generated vs. student-generated) to the first and second parts (122, 124) of the loss function 120 complements the above-described behavior of forward KL divergence and reverse KL divergence. That is, the use of teacher-generated samples yₜ is suitable for forward KL divergence (in the first part 122) to promote the effect of pulling up the student distribution q in the head region 308 where most of p(yₜ|x)>>0, and the use of student-generated samples yₛ is suitable for reverse KL divergence (in the second part 124) to promote the effect of pulling down the student distribution in the tail region 310 where most of p(yₛ|x)≅0. The use of these two types samples is also complementary because reliance on teacher-generated samples in the head region 308 promotes learning new information, but potentially causes mismatch with the dynamic data encountered during inference. On the other hand, the student-generated samples are more aligned with the capabilities of the student model 104. Therefore, the use of student-generated samples alleviates the inference mismatch present in the head region 308, but with less emphasis on learning new information.

In summary, forward and reverse KL divergence, combined with different types of samples (teaching vs. student-generated), productively complement each other. As a result, the training system 102 is able to accelerate convergence to a target state in a stable manner. As a further result, the student model 104 produced thereby exhibits high accuracy, as will be quantified in Section C.

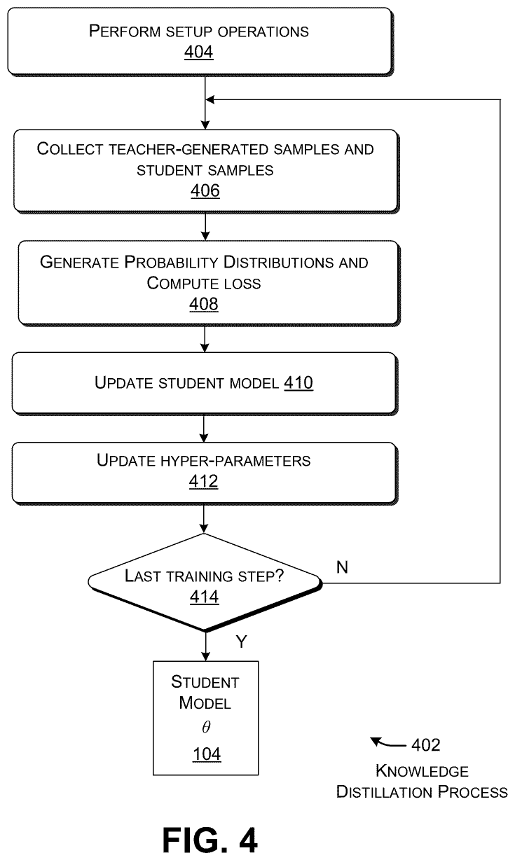

FIG. 4 shows a process 402 that explains one manner of operation of the training system 102. In block 404, the training system 102 initializes various parameters and defines various structures. For example, the training system 192 initializes the hyper-parameters for β and φ. The training system 102 also chooses an initial value for α, which is used for an initial series of iterations, after which the α-generating component 126 dynamically updates the value of a on a per-sample basis.

In some implementations, the buffer-managing component 130 produces all of the student-generated samples in block 404, and performs no iterative updating of the second store 112. In other implementations, the buffer-managing component 130 determines whether a triggering condition is met that controls the updating of the second data store 112. The triggering condition is based on the value of the hyper-parameter φ, which, in turn, is based on the outcome of a validation process. If this inquiry is answered in the affirmative, then the buffer-managing component 130 adds a subset of student-generated samples to the second data store 112 on a FIFO basis. Otherwise, the buffer-managing component 130 skips the update operation.

In block 406, the training system 102 collects a batch of samples from the teacher-generated set and a batch of samples from the student-generated set. In block 408, the teacher model 106 and the student model 104 compute probability distributions based on the batches of samples, and then the loss-generating component 118 computes a measure of loss based on the probability distributions. In block 410, the model-updating component 128 updates the parameters θ 108 of the student model 104 based on the loss that has been computed. In block 412, the hyper-parameter-updating system 132 updates the hyper-parameters, e.g., including the parameters β and φ.

In block 414, the training system 102 determines whether a target condition has been reached. Illustrative target conditions include the attainment of a prescribed degree of convergence or the completion of a prescribed number of training steps M. If the target condition has not been reached, the training system 102 repeats the above-described operations for the next iteration. If the target condition has been reached, then transfer of knowledge from the teacher model 106 to the student model 104 is complete.

Different model-developing environments are capable of making use of the training system 102. In a first example, a speculative decoding system uses the training system 102 to train its token-drafting model. A speculative decoding system pits the drafting model against a larger token-verifying model. During inference, the drafting model and the token-generating model cooperatively generate the tokens of an output response in plural passes. That is, in each pass, the drafting model generates a set of candidate tokens. The token-verifying model verifies the correctness of these tokens and rejects any token(s) that fail its correctness test.

Overall, the speculative decoding system reduces inference latency because the resource-efficient token-drafting model is responsible for autoregressively producing a portion of each output response (compared to using the larger more resource-intensive teacher model to generate all of the tokens of the output response). The training system 102 of FIG. 1 benefits a speculative decoding system because it produces a token-drafting model that is more aligned with the distribution of the token-verifying model. This has the end of effect of increasing the average number of tokens that are accepted as correct by the token-verifying model, which, in turn, reduces latency due to the increased reliance on the candidate tokens produced by the token-drafting model.

In a second example, a quantization system uses the training system 102 of FIG. 1 to improve the accuracy of a model that has been quantized. That is, quantization involves reducing the sizes of parameters used by an original model, to produce a downsized model. Quantization, however, may impair the accuracy of the down-sized model because the downsized parameters do not express the same amount of information as the original parameters. The training system 102 improves the accuracy of the down-sized model by using knowledge distillation to transfer knowledge from the original model to the down-sized model.

In other examples, the training system 102 can be integrated into a system that performs a multi-stage training processes that includes, as one of the stages, fine-tuning. More specifically, this kind of system can replace its fine-tuning stage with the training performed by the training system 102 of FIG. 1. For example, in some preference fine-tuning systems, training occurs in three steps: (1) supervised fine-tuning with human-labeled datasets; (2) reward model training; and (3) preference alignment using human feedback with Proximal Policy Optimization (PPO) or Direct Preference Optimization (DPO). Examples of this type of system are provided in Ouyang, et al., “Training language models to follow instructions with human feedback,” in Advances in neural information processing systems, 2022, 15 pages, and Rafailov, et al., “Direct Preference Optimization: Your Language Model is Secretly a Reward Model,” in Advances in Neural Information Processing Systems, 36, 2023, 14 pages. These types of preference fine-tuning systems can replace their fine-tuning stages with the training performed by the training system 102 of FIG. 1, which results in the ultimate production of models with increased alignment with human preferences.

### B. Updating Parameters α and β

In some implementations, the hyper-parameter-updating component 131 adjusts the hyper-parameter β in the following manner, as described with reference to FIG. 4. In block 404, the hyper-parameter-updating component 131 sets an initial value for β, denoted 1+τ_{B} (e.g., where τ_{β}=0.5 in one implementation). In block 412, at the end of each iteration, the hyper-parameter-updating system 132 updates the value of the hyper-parameter β. For example, assume that the training system 102 performs a total number M of iterations, each of which is denoted by m. The hyper-parameter-updating system 132 updates the value of β by using

$$β = 1 + max \{ \frac{m}{M} , {τ}_{B} \} ,$$

in which “max” uses whatever value

$$( \frac{m}{M} or {τ}_{β} )$$

is larger. In other examples, the hyper-parameter-updating system 132 dynamically increases the value of β by an amount that depends on one or more factors, such as the degree to which the student model 104 has converged to a target state, or based on some other quality-based metric.

More generally, the hyper-parameter-updating system 132 increases β as training progresses. This manner of operation is motivated by the observation that using a relatively large value of β in the late training phase causes the training system 102 to draw more heavily in this period on feedback from student-generated samples, rather than attempting to learn new information regarding the teacher-generated samples. This behavior, in turn, helps avoid inference mismatch, and to produce a more accurate student model 104. Inference mismatch arises in some examples due to the different sizes of the student model 104 and the teacher model 106, and/or the different sizes of the student-generated set Dₛ and the teacher-generated set Dₜ.

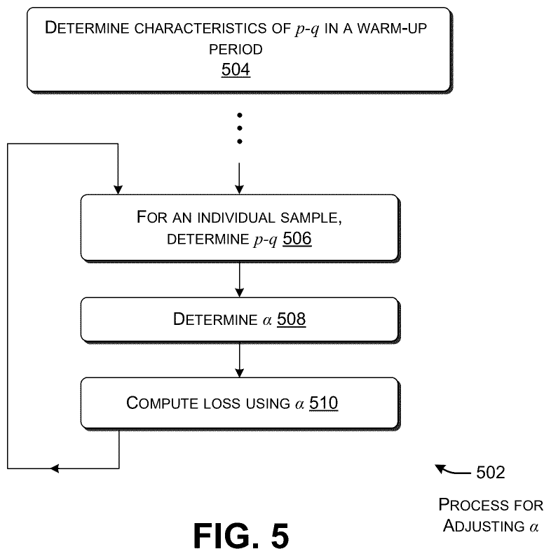

FIG. 5 shows an illustrative process 502, performed by the α-generating component 126 of FIG. 1 for dynamically generating the interpolation parameter α. As shown in Equations (6) and (7), the interpolation parameter α controls the interpolation in the skew versions of KL divergence. More specifically, in the explanation below, it will be assumed that the α-generating component 126 computes a first interpolation value α₁ for the first part 122 and a second interpolation value α₂ for the second part 124. General reference to a below is intended to represent either α₁ or α₂. In other implementations, the α-generating component 126 computes a single value for a that applies to both the first part 122 and the second part 124.

In some implementations, the α-generating component 126 produces values for α₁ and α₂ that apply to the entirety of each individual response y, including each of its G component tokens. In other examples, the loss-generating component 118 is capable of updating the interpolation parameters (α₁, α₂) on a token-by-token basis.

In block 504, the hyper-parameter-updating system 132 (or some other responsible component) sets an initial value of α (e.g., α₀) for both parts (122, 124) that remains fixed during a warm-up period, which, for example, spans the first 10 percent of the total training iterations. For example, α₀ is set to 0.1. Generally, the training system 102 uses a fixed a in this initial span because training is not yet stable in this period.

During this warm-up period, the hyper-parameter-updating system 132 also determines the differences between individual pairs of probabilities (pᵢ, qᵢ) for individual samples i in the set of teacher-generated samples, and, similarly, determines the differences between individual pairs of probabilities (pᵢ, qᵢ) for individual samples in the student-generated set. The hyper-parameter-updating system 132 also generates a mean value Δₘₑₐₙ of these differences for both the teacher-generated and student-generated sets.

The remaining operations shown in FIG. 5 describe computing the value of the interpolations (α₁, α₂) for probabilities pᵢ and qᵢ for an individual sample. More specifically, in block 506, the α-generating component 126 determines the difference between a particular teacher-generated probability pᵢ and a particular student-generated probability qᵢ. In block 508, the α-generating component 126 determines values (α₁, α₂) based on the differences, e.g., using the following equation:

$$α = 1 - ( 1 - {α}_{0} ) \cdot \frac{{Δ}_{m e a n}}{{p}_{i} - {q}_{i}} . \qquad ( 9 )$$

In this equation, α is meant to express either α₁ or α₂, depending on what part (122 or 124) is being considered. As previously described, as the difference between pᵢ−qᵢ increases, so does α. In block 510, the loss-generating component 118 computes loss using the loss function 120 based on the values of α₁ and α₂ computed in block 508.

### C. Illustrative Performance

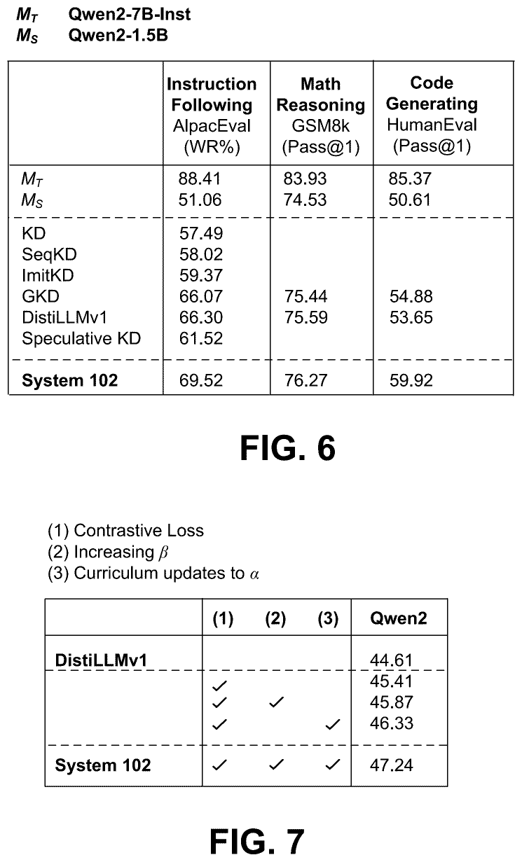

FIG. 6 describes the performance of a student model trained using the training system 102 of FIG. 1 (identified in the chart as “system 102”) with respect to models trained by competing knowledge distillation methods. The teacher model (M_{T}) in these comparisons is the Qwen2 language model having 7B parameters, and the student model (M_{S}) is the Qwen2 language model having 1.5B parameters. The competing knowledge distillation methods are: a) KD as described in Hinton, et al., “Distilling the Knowledge in a Neural Network,” in arXiv, arXiv: 1503.02531v1 [stat.ML], Mar. 9, 2015, 9 pages; b) SeqKD, as described in Kim, et al., “Sequence-Level Knowledge Distillation,” arXiv, rXiv: 1606.07947v4 [cs.CL], Sep. 22, 2016, 14 pages; c) ImitKD, as described in Lin, et al., “Autoregressive Knowledge Distillation through Imitation Learning,” in Proceedings of the 2020 Conference on Empirical Methods in Natural Language Processing (EMNLP), November 2020, pp. 6121-6133; d) GKD, as described in Agarwal, et al., “On-Policy Distillation of Language Models: Learning from Self-Generated Mistakes,” in The Twelfth International Conference on Learning Representations, published Apr. 18, 2024, 18 pages; e) DistiLLMv1, as described in Ko, et al., “DISTILLM: Towards Streamlined Distillation for Large Language Models,” arXiv, arXiv: 2402.03898v2 [cs.CL], Jul. 4, 2024, 23 pages; and f) Speculative KD, as described in Xu, et al., “Speculative Knowledge Distillation: Bridging the Teacher-Student Gap Through Interleaved Sampling,” arXiv: 2410.11325v1 [cs.CL], Oct. 15, 2024, 27 pages.

The first column measures the models' performance on an instruction-following task, as measured using the AlpacEval benchmark described in DuBois, et al., “Length-Controlled AlpacaEval: A Simple Way to Debias Automatic Evaluators,” arXiv, arXiv: 2404.04475v1 [cs.LG], Apr. 6, 2024, 11 pages. The second column measures the models' performance on a math reasoning task, as measured using the GSM8k benchmark described in Zeng, et al., “MR-GSM8K: A Meta-Reasoning Benchmark for Large Language Model Evaluation,” arXiv, arXiv: 2312.17080v4 [cs.CL], Jun. 5, 2024, 22 pages. The third column measures the models' performance on a code-generating task, as measure using the HumanEval benchmark described in Chen, et al., “Evaluating Large Language Models Trained on Code,” arXiv, arXiv: 2107.03374v2 [cs.LG] 14 Jul. 2021, 35 pages.

The first two lines describe the performance of the teacher model and the student model in their original respective forms, before knowledge distillation is performed. As can be seen, the training system 102 of FIG. 1 produces a student model that performs better than the models generated by other knowledge distillation techniques. The student model provides inferior performance only to the teacher model. Further, because the same amount of training is applied to the various models using the same type of training data, FIG. 6 also demonstrates that the training system 102 of FIG. 1 converges to a high-quality state more quickly than other models.

FIG. 7 shows the result of an ablation study in which three different features used in the training system 102 of FIG. 2 were added to the knowledge distillation approach DistLLMv1 (note: DistLLMv1, in its original form, provides none of the three features). The added features are: (1) the use of contrastive loss; (2) a provision for increasing β as training progresses; and (3) a provision for dynamically updating α based on p−q. As indicated, each of the three features individually outperforms the baseline performance of models produced using DistiLLMv1. The combination of all three features, as provided by the training system 102, produces a student model having the best performance.

It is further found that increasing the size of the teacher-generated set Dₜ and the size of the teacher model 106 both individually improve the accuracy of the student model 104. But the reason that student model 104 produced by the training system 102 produces more accurate models than competing knowledge distillation techniques is because it more effectively aligns the behavior of the student model 104 with the behavior of the teacher model 106.

### D. Illustrative Language Model

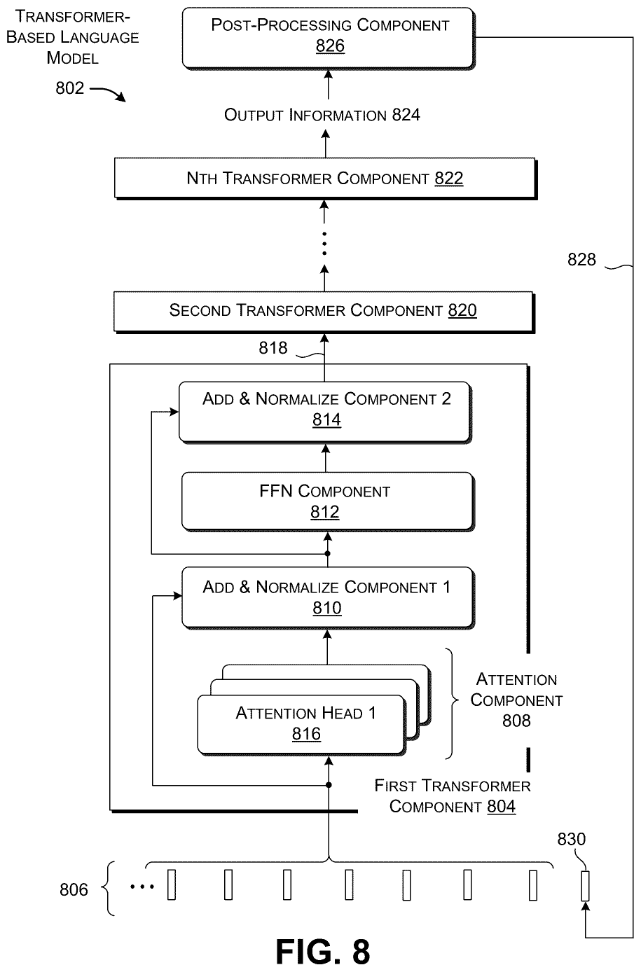

FIG. 8 shows a transformer-based language model (“language model”) 802 for implementing any of the teacher model 106 and/or the student model 104 of FIG. 1. The language model 802 is composed, in part, of a pipeline of transformer components, including a first transformer component 804. FIG. 8 provides details regarding one way to implement the first transformer component 804. Although not specifically illustrated, other transformer components of the language model 802 have the same architecture and perform the same functions as the first transformer component 804 (but are governed by separate sets of weights).

The language model 802 commences its operation with the receipt of input information, such as a passage of text. The prompt includes a series of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. The principles set forth herein, however, are not limited to the processing of text information; in other examples, the language model 802 operates on any of: audio information, image information, video information, sensor information, and so on, or any combination thereof.

Next, an embedding component (not shown) maps the sequence of tokens into respective token embeddings. For example, the embedding component produces one-hot vectors that describe the tokens, and then maps the one-hot vectors into the token embeddings using a machine-trained linear transformation. The embedding component then adds position information (and, in some cases, segment information) to the respective token embeddings to produce position-supplemented embedding vectors 806. The position information added to each token embedding describes the embedding vector's position in the sequence of token embeddings.

The first transformer component 804 operates on the position-supplemented embedding vectors 806. In some implementations, the first transformer component 804 includes, in order, an attention component 808, a first add-and-normalize component 810, a feed-forward neural network (FFN) component 812, and a second add-and-normalize component 814.

The attention component 808 determines how much emphasis should be placed on parts of input information when interpreting other parts of the input information. The attention component 808 performs attention analysis using the following equation:

$$Attention ( Q , K , V ) = softmax ( \frac{Q {K}^{T}}{\sqrt{{d}_{k}}} ) V . \qquad ( 10 )$$

The attention component 808 produces query information Q by multiplying the position-supplemented embedding vectors 806 by a query weighting matrix W^{Q}. Similarly, the attention component 808 produces key information K and value information V by multiplying the position-supplemented embedding vectors 806 by a key weighting matrix W^{K} and a value weighting matrix W^{V}, respectively. To execute Equation (10), the attention component 808 takes the dot product of Q with the transpose of K, and then divides the dot product by a scaling factor \sqrt{d}, to produce a scaled result. The symbol d represents the dimensionality of Q and K. The attention component 808 takes the Softmax (normalized exponential function) of the scaled result, and then multiplies the result of the Softmax operation by V, to produce attention output information. In some cases, the attention component 808 is said to perform masked attention insofar as the attention component 808 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 11 pages.

Note that FIG. 8 shows that the attention component 808 is composed of plural attention heads, including a representative attention head 816. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 808 concatenates the output results of the attention component's separate attention heads, and then multiplies the results of this concatenation by another weight matrix W⁰.

The add-and-normalize component 810 includes a residual connection that combines (e.g., sums) input information fed to the attention component 808 with the output information generated by the attention component 808. The add-and-normalize component 810 then normalizes the output information generated by the residual connection, e.g., by layer-normalizing values in the output information based on the mean and standard deviation of those values, or by performing root-mean-squared normalization. The other add-and-normalize component 814 performs the same functions as the first-mentioned add-and-normalize component 810. The FFN component 812 transforms input information to output information using a feed-forward neural network having any number of layers.

The first transformer component 804 produces output information 818. A series of other transformer components (820, . . . , 822) perform the same functions as the first transformer component 804, each operating on output information produced by its immediately preceding transformer component. Each transformer component uses its own level-specific set of machine-trained weights. The final transformer component 822 in the language model 802 produces final output information 824.

In some implementations, a post-processing component 826 performs post-processing operations on the final output information 824. For example, the post-processing component 826 performs a machine-trained linear transformation on the final output information 824, and processes the results of this transformation using a Softmax component (not shown). The language model 802 uses the output of the post-processing component 826 to predict the next token in the input sequence of tokens. In some applications, the language model 802 performs this task using a greedy selection approach (e.g., by selecting the token having the highest probability), or by using the beam search algorithm (e.g., by traversing a tree that expresses a search space of candidate next tokens).

In some implementations, the language model 802 operates in an autoregressive manner, as indicated by the loop 828. To operate in this way, the language model 802 appends a predicted token to the end of the sequence of input tokens, to provide an updated sequence of tokens. The predicted token leads to the production of a new position-supplemented vector 830. In a next pass, the language model 802 processes the updated sequence of position-supplemented vectors to generate a next predicted token. The language model 802 repeats the above process until it generates a specified stop token.

The above-described implementation of the language model 802 relies on a decoder-only architecture. Other implementations of the language model 802 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component).

### E. Illustrative Processes

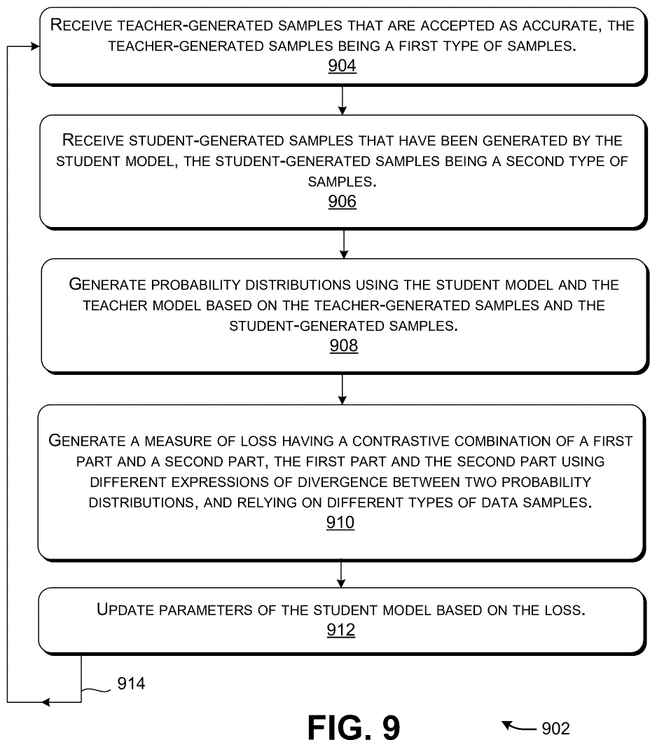

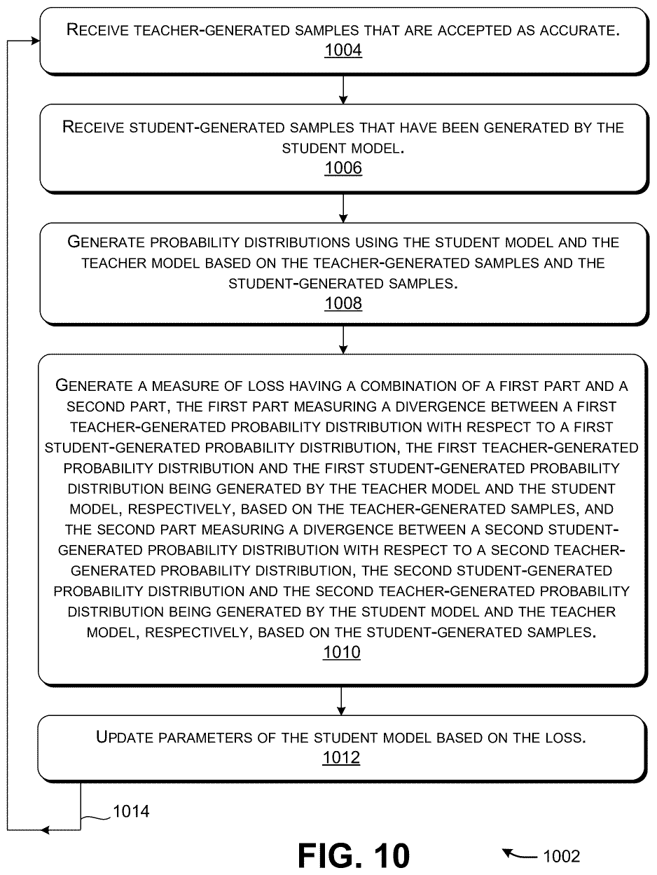

FIGS. 9 and 10 shows processes that represent an overview of the operation of the training system 102 of FIG. 1. The processes are expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 11 and 12.

More specifically, FIG. 9 shows a process 902 for training a student model (e.g., the student model 104) based on a larger teacher model (e.g., the teacher model 106). In block 904, the training system 102 receives teacher-generated samples that are accepted as accurate, the teacher-generated samples being a first type of samples. In block 906, the training system 102 receives student-generated samples that have been generated by the student model, the student-generated samples being a second type of samples. In block 908, the training system 102 generates probability distributions using the student model and the teacher model based on the teacher-generated samples and the student-generated samples. In block 910, the training system 102 generates a measure of loss having a contrastive combination of a first part and a second part, the first part and the second part using different expressions of divergence between two probability distributions, and relying on different types of data samples. In block 912, the training system 102 updates parameters of the student model based on the loss. The loop 914 indicates that the training system 102 repeats the operations of blocks 904-912 over plural iterations.

FIG. 10 shows another process 1002 for training a student model (e.g., the student model 104) based on a larger teacher model (e.g., the teacher model 106). In particular the process 1002 of FIG. 10 is a more detailed implementation of the process 902 of FIG. 9. In block 904, the training system 102 receives teacher-generated samples that are accepted as accurate. In block 1006, the training system 102 receives student-generated samples that have been generated by the student model. In block 1008, the training system 102 generates probability distributions using the student model and the teacher model based on the teacher-generated samples and the student-generated samples. In block 1010, the training system 102 generates a measure of loss having a combination of a first part and a second part. The first part measures a divergence between a first teacher-generated probability distribution with respect to a first student-generated probability distribution, the first teacher-generated probability distribution and the first student-generated probability distribution being generated by the teacher model and the student model, respectively, based on the teacher-generated samples. The second part measures a divergence between a second student-generated probability distribution with respect to a second teacher-generated probability distribution, the second student-generated probability distribution and the second teacher-generated probability distribution being generated by the student model and the teacher model, respectively, based on the student-generated samples. In block 1012, the training system 102 updates parameters of the student model based on the loss. The loop 1014 indicates that the training system 102 repeats the operations of blocks 1004-1012 over plural iterations.

### F. Illustrative Computing Devices

FIG. 11 shows computing equipment 1102 that, in some implementations, is used to implement the training system 102. The computing equipment 1102 includes a set of local devices 1104 coupled to a set of servers 1106 via a computer network 1108. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1108 is implemented as a local area network, a wide area network (e.g., the Internet), one or more point-to-point links, or any combination thereof.

The bottom-most overlapping box in FIG. 11 indicates that the functionality of the training system 102 is capable of being spread across the local devices 1104 and/or the servers 1106 in any manner. That is, the functionality of the training system 102 can be entirely implemented by a local device, or entirely implemented by a server system. Alternatively, some of the functions of the training system 102 are implemented a local device and some of the functions of the training system 102 are implemented by a server system.

FIG. 12 shows a computing system 1202 that, in some implementations, is used to implement any aspect of the mechanisms set forth in the above-described figures. For instance, in some implementations, the type of computing system 1202 shown in FIG. 12 is used to implement any local computing device or any server shown in FIG. 11. In all cases, the computing system 1202 represents a physical and tangible processing mechanism.

The computing system 1202 includes a processing system 1204 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1202 also includes computer-readable storage media 1206, corresponding to one or more computer-readable media hardware units. The computer-readable storage media 1206 retains any kind of information 1208, such as machine-readable instructions, settings, model weights, and/or other data. In some implementations, the computer-readable storage media 1206 includes one or more solid-state devices, one or more hard disks, one or more optical disks, etc. Any instance of the computer-readable storage media 1206 represents a fixed or removable unit of the computing system 1202. Further, any instance of the computer-readable storage media 1206 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1202 utilizes any instance of the computer-readable storage media 1206 in different ways. For example, in some implementations, any instance of the computer-readable storage media 1206 represents a hardware memory unit (such as random access memory (RAM)) for storing information during execution of a program by the computing system 1202, and/or a hardware storage unit (such as a hard disk) for retaining/archiving information on a more permanent basis. In the latter case, the computing system 1202 also includes one or more drive mechanisms 1210 (such as a hard drive mechanism) for storing and retrieving information from an instance of the computer-readable storage media 1206.

In some implementations, the computing system 1202 performs any of the functions described above when the processing system 1204 executes computer-readable instructions stored in any instance of the computer-readable storage media 1206. For instance, in some implementations, the computing system 1202 carries out computer-readable instructions to perform each block of the processes described with reference to FIGS. 9 and 10. FIG. 12 generally indicates that hardware logic circuitry 1212 includes any combination of the processing system 1204 and the computer-readable storage media 1206.

In addition, or alternatively, the processing system 1204 includes one or more other configurable logic units that perform operations using a collection of logic gates, such as field-programmable gate arrays (FPGAs), etc. In these implementations, the processing system 1204 effectively incorporates a storage device that stores computer-readable instructions, insofar as the configurable logic units are configured to execute the instructions and therefore embody or store these instructions.

In some cases (e.g., in the case in which the computing system 1202 represents a user computing device), the computing system 1202 also includes an input/output interface 1214 for receiving various inputs (via input devices 1216), and for providing various outputs (via output devices 1218). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1220 and an associated graphical user interface presentation (GUI) 1222. The display device 1220 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1202 also includes one or more network interfaces 1224 for exchanging data with other devices via one or more communication conduits 1226. One or more communication buses 1228 communicatively couple the above-described units together.

The communication conduit(s) 1226 is implemented in any manner, e.g., by a local area computer network, a wide area computer network (e.g., the Internet), point-to-point connections, or any combination thereof. The communication conduit(s) 1226 include any combination of hardwired links, wireless links, routers, gateway functionality, name servers, etc., governed by any protocol or combination of protocols.

FIG. 12 shows the computing system 1202 as being composed of a discrete collection of separate units. In some cases, the collection of units corresponds to discrete hardware units provided in a computing device chassis having any form factor. FIG. 12 shows illustrative form factors in its bottom portion. In other cases, the computing system 1202 includes a hardware logic unit that integrates the functions of two or more of the units shown in FIG. 12. For instance, in some implementations, the computing system 1202 includes a system on a chip (SoC or SOC), corresponding to an integrated circuit that combines the functions of two or more of the units shown in FIG. 12.

The following summary provides a set of illustrative examples of the technology set forth herein.

(A1) According to one aspect, a method (e.g., the process 1002) is described for training a student model (e.g., the student model 104) based on a larger teacher model (e.g., the teacher model 106). The method includes receiving (e.g., in block (1006) teacher-generated samples that are accepted as accurate, and receiving (e.g., in block 1006) student-generated samples that have been generated by the student model. The method further includes generating (e.g., in block 1008) probability distributions using the student model and the teacher model based on the teacher-generated samples and the student-generated samples, and generating (e.g., in block 1010) a measure of loss having a combination of a first part (e.g., the first part 122) and a second part (e.g., the second part 124). The first part measures a divergence between a first teacher-generated probability distribution with respect to a first student-generated probability distribution, the first teacher-generated probability distribution and the first student-generated probability distribution being generated by the teacher model and the student model, respectively, based on the teacher-generated samples. The second part measures a divergence between a second student-generated probability distribution with respect to a second teacher-generated probability distribution, the second student-generated probability distribution and the second teacher-generated probability distribution being generated by the student model and the teacher model, respectively, based on the student-generated samples. The method further includes updating (e.g., in block 1012) parameters of the student model based on the loss. Blocks 1004-10012 are repeated over plural iterations.

(A2) According to some implementations of the method of A1, the student model and the teacher model are respective language models.

(A3) According to some implementations of the methods of A1 or A2, the generating a measure of the loss uses forward Kullback-Leibler divergence to generate the first part, and reverse Kullback-Leibler divergence to generate the second part.

(A4) According to some implementations of the method of A3, the first part causes the first student-generated probability distribution to increase in a head region of the first teacher-generated probability distribution, and the second part causes the second student-generated probability distribution to decrease in a tail region of the first teacher-generated probability distribution.

(A5) According to some implementations of any of the methods of A1-A4, the generating a measure of loss includes: interpolating between the first teacher-generated probability distribution and the first student-generated probability distribution based on a first interpolation parameter; and interpolating between the second student-generated probability distribution and the second teacher-generated probability distribution based on a second interpolation parameter.

(A6) According to some implementations of the method of A5, the first interpolation parameter and the second interpolation parameter are computed separately.

(A7) According to some implementations of the method of A5 or A6, the method further includes dynamically setting a value of each interpolation parameter for a pairing of individual probabilities under consideration based on a difference between the pairing of individual probabilities.

(A8) According to some implementations of the method of A7, the value of each interpolation parameter increases as the difference between the pairing of individual probabilities increases.

(A9) According to some implementations of the method of A7 or A8, the value of each interpolation parameter depends a range of differences between pairs of individual probabilities, as assessed during an initial period of training.

(A10) According to some implementations of any of the methods of A1-A9, the method further includes weighting the first part with respect to the second part of the measure of loss using a part-weighting parameter.

(A11) According to some implementations of the method of A10, the method further includes dynamically changing the part-weighting parameter over a course of the iterations to increase emphasis on the second part.

(A12) According to some implementations of any of the methods of A1-A11, the teacher model and the student model are a token-verifying model and a token-drafting model in a speculative decoding system.

(A13) According to some implementations of any of the methods of A1-A11, the teacher model and the student model are an original unquantized model and a quantized model, and wherein the training is used to restore accuracy of the quantized model that has been lost in quantization.

(A14) According to some implementations of any of the methods of A1-A11, the method is used to replace a supervised fine-tuning operation in a multi-stage training process.

(B1) According to one aspect, a method (e.g., the process 902) is described for training a student model (e.g., the student model 104) based on a larger teacher model (e.g., the teacher model 106). The method relies on a first sample store (e.g., data store 110) for storing teacher-generated samples that are accepted as accurate, and a second sample store (e.g., data store 112) for storing student-generated samples that have been generated by the student model. The method includes generating (e.g. in block 908) probability distributions using the student model and the teacher model based on the teacher-generated samples and the student-generated samples, and generating (e.g., in block 910) a measure of loss having a combination of a first part (e.g., the first part 122) and a second part (e.g., the second part 124). The first part measures a divergence between a first teacher-generated probability distribution with respect to a first student-generated probability distribution, the first teacher-generated probability distribution and the first student-generated probability distribution being generated by the teacher model and the student model, respectively, based on the teacher-generated samples. The second part measures a divergence between a second student-generated probability distribution with respect to a second teacher-generated probability distribution, the second student-generated probability distribution and the second teacher-generated probability distribution being generated by the student model and the teacher model, respectively, based on the student-generated samples. The method further incudes updating (e.g., in block 912) parameters of the student model based on the loss. Blocks 908, 910, and 912 are repeated over plural iterations.

In yet another aspect, some implementations of the technology described herein include a computing system (e.g., the computing system 1202) that includes a processing system (e.g., the processing system 1204) having a processor. The computing system also includes a storage device (e.g., the computer-readable storage media 1206) for storing computer-readable instructions (e.g., the information 1208).

The processing system executes the computer-readable instructions to perform any of the methods described herein (e.g., any individual method of the methods of A1-A14 and B1).

In yet another aspect, some implementations of the technology described herein include a computer-readable storage medium (e.g., the computer-readable storage media 1206) for storing computer-readable instructions (e.g., the information 1208). A processing system (e.g., the processing system 1204) executes the computer-readable instructions to perform any of the operations described herein (e.g., the operations in any individual method of the methods of A1-A14 and B1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1212 of FIG. 12. The term “logic” likewise encompasses various physical and tangible mechanisms for performing a task. For instance, each processing-related operation illustrated in the flowcharts of FIGS. 15 and 16 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for training a student model based on a larger teacher model, comprising:
receiving teacher-generated samples that are accepted as accurate;
receiving student-generated samples that have been generated by the student model;
generating probability distributions using the student model and the teacher model based on the teacher-generated samples and the student-generated samples;
generating a measure of loss having a combination of a first part and a second part,
the first part measuring a divergence between a first teacher-generated probability distribution with respect to a first student-generated probability distribution, the first teacher-generated probability distribution and the first student-generated probability distribution being generated by the teacher model and the student model, respectively, based on the teacher-generated samples, and
the second part measuring a divergence between a second student-generated probability distribution with respect to a second teacher-generated probability distribution, the second student-generated probability distribution and the second teacher-generated probability distribution being generated by the student model and the teacher model, respectively, based on the student-generated samples; and
updating parameters of the student model based on the loss,
the receiving teacher-generated samples, the receiving student-generated samples, the generating probability distributions, the generating a measure of loss, and the updating being repeated over plural iterations.

2. The method of claim 1, wherein the student model and the teacher model are respective language models.

3. The method of claim 1, wherein the generating a measure of the loss uses forward Kullback-Leibler divergence to generate the first part, and reverse Kullback-Leibler divergence to generate the second part.

4. The method of claim 3, wherein the first part causes the first student-generated probability distribution to increase in a head region of the first teacher-generated probability distribution, and the second part causes the second student-generated probability distribution to decrease in a tail region of the first teacher-generated probability distribution.

5. The method of claim 1, wherein the generating a measure of loss comprises:
interpolating between the first teacher-generated probability distribution and the first student-generated probability distribution based on a first interpolation parameter; and
interpolating between the second student-generated probability distribution and the second teacher-generated probability distribution based on a second interpolation parameter.

6. The method of claim 5, wherein the first interpolation parameter and the second interpolation parameter are computed separately.

7. The method of claim 5, further comprising dynamically setting a value of each interpolation parameter for a pairing of individual probabilities under consideration based on a difference between the pairing of individual probabilities.

8. The method of claim 7, where the value of each interpolation parameter increases as the difference between the pairing of individual probabilities increases.

9. The method of claim 7, wherein the value of each interpolation parameter depends a range of differences between pairs of individual probabilities, as assessed during an initial period of training.

10. The method of claim 1, further comprising weighting the first part with respect to the second part of the measure of loss using a part-weighting parameter.

11. The method of claim 10, further comprising dynamically changing the part-weighting parameter over a course of the iterations to increase emphasis on the second part.

12. The method of claim 1, wherein the teacher model and the student model are a token-verifying model and a token-drafting model in a speculative decoding system.

13. The method of claim 1, wherein the teacher model and the student model are an original unquantized model and a quantized model, and wherein the training is used to restore accuracy of the quantized model that has been lost in quantization.

14. The method of claim 1, wherein the method is used to replace a supervised fine-tuning operation in a multi-stage training process.

15. A computing system for training a student model based on a larger teacher model, comprising:
a first sample store for storing teacher-generated samples that are accepted as accurate;
a second sample store for storing student-generated samples that have been generated by the student model;
an instruction data store for storing computer-readable instructions; and
a processing system for executing the computer-readable instructions in the instruction data store, to perform operations including:
generating probability distributions using the student model and the teacher model based on the teacher-generated samples and the student-generated samples;
generating a measure of loss having a combination of a first part and a second part,
the first part measuring a divergence between a first teacher-generated probability distribution with respect to a first student-generated probability distribution, the first teacher-generated probability distribution and the first student-generated probability distribution being generated by the teacher model and the student model, respectively, based on the teacher-generated samples, and
the second part measuring a divergence between a second student-generated probability distribution with respect to a second teacher-generated probability distribution, the second student-generated probability distribution and the second teacher-generated probability distribution being generated by the student model and the teacher model, respectively, based on the student-generated samples; and
updating parameters of the student model based on the loss,
the generating probability distributions, the generating a measure of loss, and the updating being repeated over plural iterations.

16. The computing system of claim 15, wherein the generating a measure of the loss uses forward Kullback-Leibler divergence to generate the first part, and reverse Kullback-Leibler divergence to generate the second part.

17. The computing system of claim 15, wherein the generating a measure of loss comprises:
interpolating between the first teacher-generated probability distribution and the first student-generated probability distribution based on a first interpolation parameter; and
interpolating between the second student-generated probability distribution and the second teacher-generated probability distribution based on a second interpolation parameter.

18. The computing system of claim 17, further comprising dynamically setting a value of each interpolation parameter for a pairing of individual probabilities under consideration based on a difference between the pairing of individual probabilities.

19. The computing system of claim 15, further comprising weighting the first part with respect to the second part of the measure of loss using a part-weighting parameter.

20. A computer-readable storage medium for storing computer-readable instructions, a processing system executing the computer-readable instructions to perform operations, the operations comprising each of:
receiving teacher-generated samples that are accepted as accurate, the teacher-generated samples being a first type of samples;
receiving student-generated samples that have been generated by the student model, the student-generated samples being a second type of samples;
generating probability distributions using a student model and a teacher model based on the teacher-generated samples and the student-generated samples;
generating a measure of loss having a contrastive combination of a first part and a second part, the first part and the second part using different expressions of divergence between two probability distributions, and relying on different types of data samples; and
updating parameters of the student model based on the loss,
the receiving teacher-generated samples, the receiving student-generated samples, the generating probability distributions, the generating a measure of loss, and the updating being repeated over plural iterations.
